(19) United States
(12) Patent Application Publication
(10) Pub. No.: US 2026/0334393 A1
(43) Pub. Date: Oct. 29, 2026

(54) SELF-WATERING PLANTER

(71) Applicant: Meghan A. Meier, Holland, MI (US)

(72) Inventor: Meghan A. Meier, Holland, MI (US)

(21) Appl. No.: 18/445,682

(22) Filed: Mar. 1, 2024

(51) Int. Cl. A01G 27/02

(52) U.S. Cl. CPC A01G 27/02

(57) ABSTRACT

A self-watering planter includes an inner pot that is received in an outer pot, the pots being releasably secured together and defining a water chamber. The outer pot has a continuous lower portion that defines the water chamber, and an upper portion defining a plant-receiving portion. The inner pot has an upper plant-receiving portion that is received in the upper portion of the outer pot, and a hollow leg extending downwardly into the lower portion of the outer pot. The hollow leg defines an opening for receiving water from the water chamber, and the hollow leg can be releasably secured to the lower portion of the outer pot, such as by corresponding fastener portions. To facilitate filling the water chamber with water, the upper plant-receiving portion defines an elongate recess extending downwardly from an upper edge and open to the water chamber.

### FIELD

The present invention relates to plant pots or planters, and more particularly, to plant pots with water reservoirs that allow a potted plant to draw water as needed.

### BACKGROUND

Standard plant pots or planters have a single chamber for holding soil, plant roots, water, and sometimes rocks or gravel at the bottom. Sealed pots or planters may be sealed, in which case over-watering can cause over-saturation of the soil or even puddling on the soil surface, but which will not result in outflow of water if the soil is simply over-saturated. Other pots or planters may have one or more drainage holes formed in their lower surface(s) so that excess water can drain out through the bottom, in which case it is usually desirable (particularly for indoor plants) to provide a water-tight tray or other support so that water outflow can be captured in the tray to avoid soiling other surfaces. There are also self-watering planters that hold moist soil and plant roots in one chamber, and that hold water in a separate chamber with some limited fluid connection between the chambers so that the plant roots may draw water from the separate water chamber as needed, while a significant portion of the soil avoids reaching an over-saturated state because it is typically elevated above the water level in the separate water chamber.

### SUMMARY

The present invention provides a self-watering planter having an aesthetic outer pot that is substantially sealed against water flow and can therefore serve as a water chamber, plus an inner pot that includes one or more hollow legs extending down from a bottom wall and releasably connecting to a bottom wall of the outer pot. A recess formed in a sidewall of the inner pot facilitates adding water to the water chamber by pouring water down between the inner pot's sidewall at the recess, and a portion of the outer pot's sidewall that is aligned with the recess. At least one of the hollow legs defines an opening so that water may flow from the chamber to the interior of that leg. A fastener at the bottom of each of the legs aligns and mates with a corresponding set of fasteners along an upper surface of the outer pot's bottom wall. The fasteners may be releasable, optionally with a retention force that is sufficient to retain the outer pot with the inner pot if the inner pot is lifted. However, with sufficient pull-apart force, the outer pot may be separated from the inner pot such as to facilitate cleaning or re-potting a plant.

These and other objects, advantages, purposes and features of this invention will become apparent upon review of the following specification in conjunction with the drawings.

### BRIEF DESCRIPTION OF THE DRAWINGS

FIG. 1 is a side perspective view of a self-watering planter in accordance with the present invention;

FIG. 2 is a side elevation view of the self-watering planter, showing the inner pot (“insert”) partially removed from the outer pot (“decorative planter”);

FIG. 3 is a side perspective view of the self-watering planter of FIG. 2;

FIG. 4 is a side sectional elevation view of the self-watering planter of FIGS. 2 and 3;

FIG. 5 is a side perspective view of the inner pot of the self-watering planter;

FIG. 6 is a bottom perspective view of the inner pot;

FIG. 7 is a top perspective view of the inner pot;

FIG. 8 is a side sectional elevation view of the self-watering planter including both the inner and outer pots in their mated configuration;

FIG. 9 is a top plan view of the self-watering planter of FIG. 8;

FIG. 10 is a top plan view of the outer pot of the self-watering planter;

FIGS. 11A and 11B are side elevation views of the outer pot;

FIG. 12 is a side-top perspective view of the outer pot;

FIG. 13 is a top plan view of the inner pot of the self-watering planter;

FIGS. 14A and 14B are side elevation views of the inner pot; and

FIG. 15 is a side-top perspective view of the inner pot.

### DESCRIPTION OF THE PREFERRED EMBODIMENTS

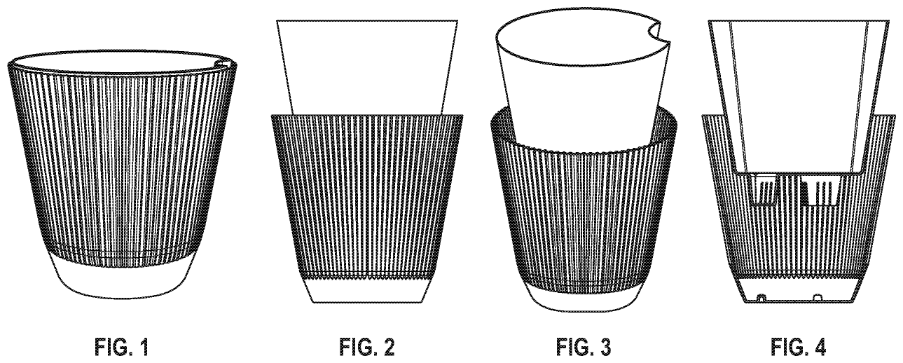

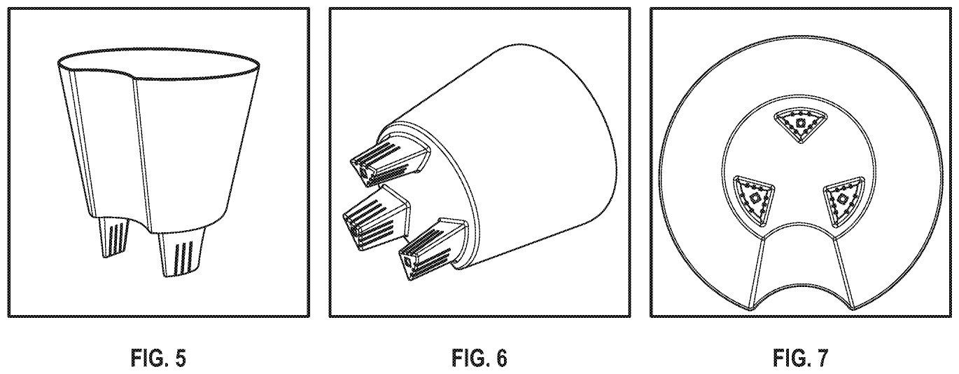

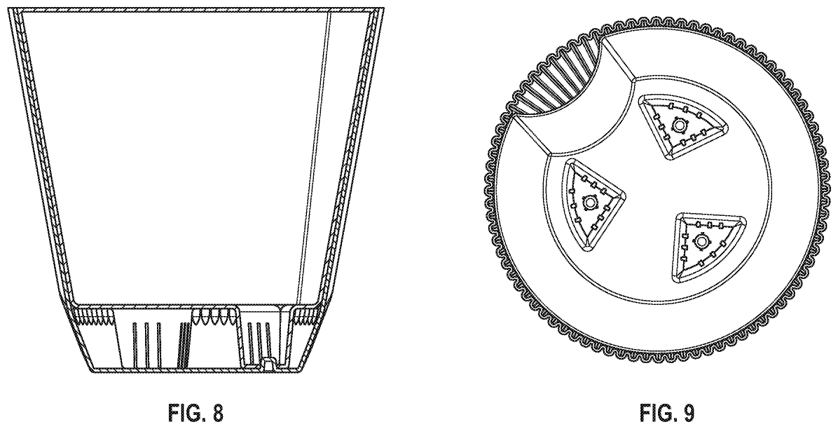

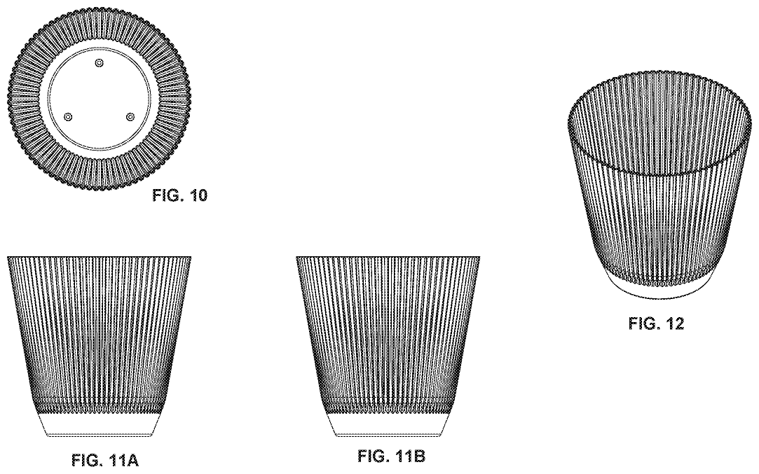

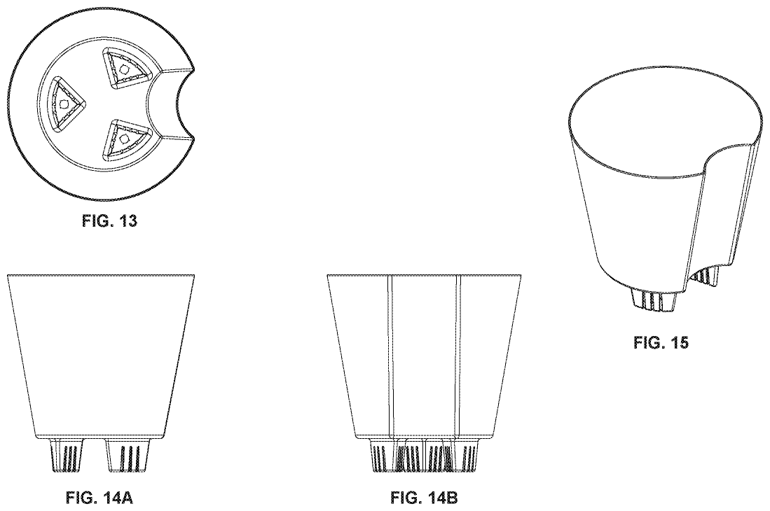

Referring now to the drawings and illustrative embodiments depicted therein, a self-watering planter (FIGS. 1-4, 8 and 9) is made up of two one-piece structures (FIGS. 1-4, 8, and 9), which are an outer pot (also referenced as a “base” or decorative portion or decorative planter, shown in FIGS. 1-4 and 8-12) and an inner pot (also referenced as an “insert”, shown in FIGS. 1-9 and 13-15) that nests inside the outer pot or base as shown in FIGS. 1, 8, and 9. The outer pot has no holes in its lower region (see FIGS. 10-11B), so that the lower region can serve as a water chamber (FIG. 8). The inner pot directly contains moist soil and plant roots. The inner pot has hollow extension legs at the bottom (FIGS. 4-9 and 13-15), the extension legs having corresponding snap-fit features, which in the illustrated embodiment are holes defined by flexible edges (FIGS. 6, 7, and 13). The flexible edges at these holes are configured to releasably engage corresponding snap-fit features (illustrated as protrusions) at the bottom of the outer water-holding pot, such as with an interference fit, as best shown in FIGS. 8 and 9. Instead of an interference fit between posts and holes, it is envisioned that other types of fasteners may be used, such as magnetic fasteners, hook-and-loop fasteners, snap fasteners, twist-to-lock fasteners, suction cup fasteners, and the like.

Openings or slots along the hollow legs (FIGS. 4-9 and 13-15) are provided for allowing water from the water chamber to flow into the hollow legs and thereby contact soil in the hollow legs. The resulting moisture can be drawn into the plant by its roots, and can be drawn upwardly into the soil, even above the water level in the water chamber, such as by capillary action. The inner pot has a concave recess along one side (best shown in FIGS. 1, 3, 5, 7, 9, 13, 14B, and 15), which facilitates pouring water between the inner pot and outer pot to facilitate filling the water chamber at the bottom of the outer pot, around the inner pot's extension legs.

Reference to the appended drawings, FIGS. 1-15, will provide a more complete understanding of the self-watering planter and its various components.

Changes and modifications in the specifically described embodiments can be carried out without departing from the principles of the present invention which is intended to be limited only by the scope of the appended claims, as interpreted according to the principles of patent law including the doctrine of equivalents.

1. A self-watering planter comprising:
an outer pot having a continuous lower portion defining a water chamber and an upper portion defining a plant-receiving region;
an inner pot having an upper plant-receiving portion that is received in said upper portion of said outer pot, and a hollow leg extending downwardly into said lower portion of said outer pot;
said hollow leg defining an opening for receiving water from said water chamber, and said hollow leg configured to be releasably secured to said lower portion of said outer pot;
said upper plant-receiving portion of said inner pot defining an elongate recess extending downwardly from an upper edge and open to said water chamber.

2. The self-watering planter of claim 1, comprising three of said hollow legs arranged symmetrically at 120-degree spacing around a lower portion of said inner pot.

3. The self-watering planter of claim 1, wherein said hollow leg or legs each defines an upper fastener portion and said outer pot defines one or more corresponding lower fastener portions for releasably receiving respective ones of said upper fastener portions when said inner pot is inserted into said outer pot in an aligned orientation.

4. The self-watering planter of claim 3, wherein said upper and lower fastener portions are configured to collectively support the entire weight of said outer pot when said self-watering planter is lifted solely by said inner pot.

5. The self-watering planter of claim 4, wherein said upper and lower fastener portions are configured to collectively support the entire weight of said outer pot with said water chamber filled with water, when said self-watering planter is lifted solely by said inner pot.

6. The self-watering planter of claim 2, wherein said hollow leg or legs each defines an upper fastener portion and said outer pot defines one or more corresponding lower fastener portions for releasably receiving respective ones of said upper fastener portions when said inner pot is inserted into said outer pot in an aligned orientation.

7. The self-watering planter of claim 6, wherein said upper and lower fastener portions are configured to collectively support the entire weight of said outer pot when said self-watering planter is lifted solely by said inner pot.

8. The self-watering planter of claim 7, wherein said upper and lower fastener portions are configured to collectively support the entire weight of said outer pot with said water chamber filled with water, when said self-watering planter is lifted solely by said inner pot.
